(19) United States
(12) Patent Application Publication
(10) Pub. No.: US 2023/0364529 A1
(43) Pub. Date: Nov. 16, 2023

(54) CONTAINMENT AND REMOVAL SYSTEM FOR DRAG AND DREGS IN A DECANTER USED IN THE SOLVENT EXTRACTION PROCESS

(71) Applicants: CONSULTORIAS Y SERVICIOS MINEROS INTEGRALES LIMITADA, Copiapó (CL); DE RE METALLICA INGENIERIA SPA, Santiago (CL)

(72) Inventors: Jorge Maximiliano MENACHO LLAÑA, Santiago (CL); Yadranka Ivana Zivkovic Domic, Santiago (CL); Eladio Rojas Veliz, Copiapo (CL)

(73) Assignees: CONSULTORIAS Y SERVICIOS MINEROS INTEGRALES LIMITADA, Copiapó (CL); DE RE METALLICA INGENIERIA SPA, Santiago (CL)

(21) Appl. No.: 18/316,533

(22) Filed: May 12, 2023

(30) Foreign Application Priority Data
May 12, 2022 (CL) 202201247

(51) Int. Cl. B01D 17/00; B01D 17/04; B01D 11/04

(52) U.S. Cl. CPC B01D 17/10; B01D 11/0449; B01D 17/045; C25C 7/06

(57) ABSTRACT

Containment and removal system for drag and sludge that constitutes a barrier to contain drag from aqueous to organic and from organic to aqueous, which can be used in a settler (settler) for solvent extraction processes, being designed to filter sludge, generate the sedimentation of aqueous droplets in organic and/or organic droplets in aqueous, and/or favor the coalescence of aqueous droplets from the organic phase, avoiding contamination due to the presence of drag and sludge.

### CROSS REFERENCE TO RELATED APPLICATIONS

This application claims priority to Chilean Patent application No. CL 202201247, filed on May 12, 2022, the entire contents of which are incorporated herein by reference.

### TECHNICAL FIELD

The invention patent is developed in the field of equipment to retain aqueous-in-organic and organic-in-aqueous drag, in solvent extraction processes, specifically referring to a barrier to contain aqueous-organic and organic-aqueous drag in settlers used in solvent extraction processes, with high efficiency and increased operational availability.

### DESCRIPTION OF THE PRIOR ART

Solvent extraction (SX) is a chemical-metallurgical process, which is wherein by intimately mixing aqueous and organic phases, and then allowing them to separate, to start a new mixing and separation cycle continuously throughout the useful life of the plant. In this process, the separation of the phases is not perfect, so there is always a contamination of the phases with remnants in the opposite phase.

In the case of copper, the solvent extraction process consists of the purification and concentration by organic nature reagents of the solutions (PLS), which come out of the leaching piles, in which said reagents selectively extract copper. In the solvent extraction process there is a copper extraction stage and a discharge stage ( stripping ), in order to obtain a purer and more concentrated solution (Rich Electrolyte) which then goes to the electrowinning stage. The contact stages between the PLS or the poor electrolyte with the organic reagent are carried out in a mixer-settler equipment (mixer-settler ), occurring in the decanter equipment ( settlers ), the separation of the aqueous phase and the organic phase. The aqueous phase, being of greater density, remains under the organic phase.

Organic-in-aqueous (O/A) carryovers generate costly extractant and diluent losses when they are contained in the refining solutions that return to leaching, where they also cause obstruction of the drippers that leach the heap, decreasing irrigation efficiency and of the recovery of valuable elements.

Organic-aqueous carryovers in the electrowinning advance solution, in the case of copper, adhere to the polypropylene spheres, reducing their efficiency in retaining acid mist. The entrained organic also contaminates the cathodes, which results in a lower quality of the marketable product.

On the other hand, the dragging of aqueous in the charged organic (A/O) transfers impurities from the extraction circuit to the re-extraction circuit, with various negative effects. Iron, chloride, nitrate and manganese are among the most harmful impurities transferred as A/O carryover. Excessive levels of iron in the electrolyte decrease current efficiency, since instead of depositing copper, they reduce the ferric ion to ferrous at the cathode and oxidize the ferrous ion to ferric at the anode, wasting energy.

For its part, chloride, in concentrations above 30 ppm in the electrolyte, generates corrosion by pitting in high-cost permanent cathodes, in addition, copper anchored by pitting is difficult to remove, which decreases the productivity of the peeling machine. of cathodes, with the consequent financial impact.

In addition, the nitrate in the highly acidic electrolyte generates nitronium ion, which can attack the organic extractant in the stripping stage, producing its chemical degradation, either hydrolytic or by nitration.

The manganese carried over to the electrolyte often ends up as sludge at the bottom of the electrowinning cells. This mud is MnO₂, which is formed by oxidation of Mn ²⁺ to Mn ⁷⁺ and then reduction of the latter to Mn ⁴⁺, which precipitates in an acid medium as manganese dioxide, in the form of pyrolusite and also as manganite -manganous, MnMnO ₃. These precipitates produce contamination of the cathodes, in turn, the Mn⁷⁺ can detach Pb from the anodes and can even attack the oxime molecule, generating highly adherent and surfactant degraded products identified as benzisoxazole structures.

In solvent extraction plants, stable emulsions are normally formed, with 40% to 60% aqueous, a similar proportion of organic, and 5% to 10% very fine solids, such emulsions are called crude, sludge, gunk, or simply sludge, which comes into contact with the organic phase, generating a third phase that is evident in the settler, in the intermediate zone between the organic phase and the aqueous phase, although it can also be present in other parts of the organic phase. This emulsion generates a nonuniform and accelerated flow of the organic that occupies part of the decanter, mainly altering the normal sedimentation of aqueous drops, which ultimately translates into higher A/O carryovers. Faced with brief changes in operation, sludge runs or “ gunk run” occur, which is the overflow of sludge in the organic dump, producing massive organic contamination, which cannot be retained by haulage containment systems A /O, coalescers, post settler and scrubbers, which translates into massive contamination of the electrolyte before electrowinning. When the mixer (mixer) is operated in continuous organic (aqueous-organic dispersion), the fluff can induce a partial or total change in the phase continuity, since, due to its hydrophilic nature, it tends to stabilize organic-aqueous dispersions. Due to the above, it is a common practice to remove sludge from the decanters with such a frequency that it does not accumulate more than 5 cm in the vicinity of the organic dump, for example. The continuous organic operation is favorable because it produces mechanical rupture of the fluff in situ, partially reducing the production rate of said fluff, but in organic continuity, the A/O carryovers increase almost double compared to a continuous aqueous operation, then in the addition and subtraction, it is not evident the convenience of operating at all events in continuous organic or in continuous aqueous.

On the other hand, the O/A carryovers in the outlet solutions, contained in the refined solutions that return to the batteries and contained in the advance electrolyte that goes to electrowinning, produce high-cost losses of the organic phase, clogging of drippers. in the batteries and cathode contamination in EW, respectively.

Current technology to contain O/A carryovers in refining solutions consists of devices that clean the refining pools, either by suction with a suitable vacuum cleaner or by adherence to a spongy material, called coalescing tapes.

In the case of O/A drags in the electrowinning advance solution, flotation columns of very low efficiency are used or, alternatively, filters filled with sand, anthracite and garnet, which retain O/A drags and other impurities. This last equipment requires frequent backwash cycles, which lowers its operational use.

The A/O carryovers in the loaded organic are retained in washing stages with acidified water without significant chloride contents, with very high investment, since a washing r-settler mixer is similar to an extraction production mixer-settler or re-extraction.

With the same objective of retaining A/O carryovers in charged organic, post-decanter units are used, commonly called DOC, which consist of a tank similar to the SX decanters, with or without baffles and a false inclined floor, through which it circulates and is separates the aqueous originally contained in the A/O drags, the efficiency of these devices being generally low.

Another option available to retain A/O drags in loaded organic, consists in the use of Chuquicamata-type coalescers, which consist of vertical cylindrical tanks, equipped with a lower feeding system and an upper overflow of clean organic output, the central zone It is made up of a set of cartridges filled with polypropylene shavings or wood chips, which coalesce the aqueous drops, which, because they are heavier, settle to the bottom of the equipment, below the feed level, through which the separated aqueous is evacuated, continuously or periodically. Coalescers require backwash stages, as they clog with lees very easily. Backwashing is cumbersome and often has low efficiency which limits its use.

Other auxiliary devices used in decanters are pickets fences, which consist of one or more rows of vertical bars, which cross the width and height of the decanter, the pickets fences standardize the velocity profile, especially the organic one. In conventional plants a picket is used “V” fence arranged in the feed, in combination with additional runs arranged in other places of the decanter. The retention of lint in the picket fences deteriorates its task of standardizing the speed of the organic. In another picket design fences, two rows of rectangular and concentric grids are arranged, which standardize the flow, but are easily clogged with the circulating litter.

Due to their operation, the described devices become clogged in a short time, requiring their replacement and/or washing, where handling of the devices is difficult, due to the additional weight due to the presence of lint or drag.

Picket -type flow distribution arrangement fence arranged between the walls of the apparatus in the form of a row.

Another document to consider is document US 7,695,625 which discloses an apparatus for reducing the carryover of aqueous, or impurities, or both, from an organic extraction solution, comprising a droplet coalescer, through which the flow of organic passes. to increase the size of the aqueous droplets, wherein said coalescer extends between the walls of the apparatus.

Document CL200300920 can also be considered, which describes equipment for the controlled separation of a dispersion, made up of an aqueous solution and an organic solution within its own phases, in relation to the recovery of metals in a liquid-liquid extraction settler, wherein said settler is equipped with 1 to 6 inverting elements, located from one side wall to the other and across with respect to the longitudinal axis of the settler, wherein said inverting element comprises at least two inverting plates located at different heights, and where the inverter boards are primarily solid, wherein the first inverter board of the inverter element, and then each of the second inverter boards, is located higher than the second and any other boards after it.

None of the above documents teach a containment and removal system for drags and sludge to retain drags from aqueous to organic and from organic to aqueous, to be used, for example, in a settler used in solvent extraction processes, which increases availability through the use of a cartridge arrangement with interchangeable units for fluff filtration, settling of aqueous-in-organic droplets and/or organic-in-aqueous droplets, and coalescence of aqueous droplets from the organic phase and droplets of organic in the aqueous phase, reducing contamination in the decanter, where said interchangeable units are easy to handle, allowing to maintain the operation of the system in a stable way, when it is required to replace a unit when it is clogged.

### SUMMARY OF THE INVENTION

The invention discloses a containment and removal system for drag and sludge that constitutes a barrier to contain aqueous-to-organic and organic-to-aqueous carryover, which can be used in a settler for solvent extraction processes. The system is designed to filter the lees, generate the sedimentation of aqueous droplets in organic and/or organic droplets in aqueous, and/or promote the coalescence of aqueous droplets from the organic phase, avoiding contamination due to the presence of carryovers and lees, of the organic and of the advance electrolyte to electrowinning, as well as allowing cleaning of the aqueous output solutions, removing droplets of organic contained in the refined solution, which returns to the leaching piles after passing through the refined and in the rich electrolyte, which goes to electrowinning.

Another objective of the invention is to provide a system for the containment and removal of drag and sludge that allows the continuous operation of the system to be maintained in a stable manner, when it is required to replace an element thereof.

Another objective of the invention is to provide a containment and removal system for drag and litter with high operational availability.

Another objective of the invention is to provide a containment and removal system for drag and sludge that allows cleaning in situ, and during continuous operation, of the elements of the system.

The containment and removal system of drags and litter corresponds to a picket system fence or cartridge -type fence or cartridge, which comprises a plurality of cartridges arranged in an arrangement in the form of a run or row that extends to the width and height of the decanter and arranged in a normal direction to the flow of organic and aqueous. The cartridges are fixed to each other to form the run or row.

Each cartridge comprises a plurality of interchangeable units arranged one behind the other, being adjacent to each other, and mounted or inserted in compartments of a cartridge frame, said frame comprising holding means for fixing with other cartridges. The compartments are made up of guides that define the spaces for mounting the interchangeable units.

System operation is designed so that when a run of interchangeable units is removed, there is always at least one run of interchangeable units in the system to maintain continued stable operation. In this way, to prevent any section or cartridge from being uncovered by the flow, each cartridge comprises at least two interchangeable units. The interchangeable units consider at least one of the mechanisms that determine carryovers, these being: filtration of lees, sedimentation of aqueous drops in organic and/or organic drops in aqueous, and coalescence of aqueous drops from the organic phase. and also coalescence of organic droplets contained in the aqueous phase.

In one arrangement, each cartridge comprises at least three interchangeable units, which consider at least one of the mechanisms that determine the carryovers, whether it is the filtration of lees, sedimentation of drops of aqueous in organic and/or of drops of organic in aqueous, and coalescence of aqueous droplets from the organic phase. Likewise, in the lower aqueous phase, they consider the occurrence of sedimentation of organic droplets in aqueous and coalescence of organic droplets from the aqueous phase. The interchangeable units are arranged one behind the other, allowing individually to promote, at least, the retention of fluff by filtration, the sedimentation of aqueous droplets in organic and sedimentation of organic droplets in aqueous or the coalescence of aqueous droplets and droplets of organic in the respective complementary phases.

Lifting means, which allows manipulation for mounting in the frame compartments or for removal when they show wear or damage, are dirty or clogged due to continuous use. The handling of the interchangeable units is easier than in traditional systems, since the weight of the clogged units is much less than the devices used in the state of the art.

In this arrangement, the operation of the system is designed so that when a run of interchangeable units is removed, there are always at least one or more runs of interchangeable units in the system to maintain continuous operation in a stable manner.

The containment and removal system for drag and fluff can also comprise an extraction or suction device, for the application of a cleaning process in situ of the interchangeable units that face the flow, in order to increase the cleaning cycles of said units. interchangeable, thus maintaining the operation of the system for a longer time, without the need to replace said units due to wear or damage, dirt or clogging of these.

### BRIEF DESCRIPTION OF THE FIGURES

FIG. 1 shows the shell of cartridges according to one embodiment of the invention.

FIG. 2A shows an example of the first unit being inserted into the cartridge frame.

FIG. 2B shows an example of a second drive that is inserted into the cartridge cage.

FIG. 2C shows an example of a third drive that is inserted into the cartridge frame.

FIG. 3 shows a schematic view of the arrangement of cartridges in the form of a run or row according to an embodiment of the invention.

FIG. 4 shows a clamping structure to secure the run of cartridges according to an embodiment of the invention.

FIG. 5 shows an upper passageway for access to the cartridges according to one embodiment of the invention.

FIG. 6 shows a run of cartridges that includes the fixing structure and the upper corridor.

FIG. 7 shows a drive replacement and cleaning sequence in accordance with one embodiment of the invention.

FIG. 8 shows examples of installation of the containment system and removal of drag and sludge in traditional decanters.

### DETAILED DESCRIPTION OF THE INVENTION

The invention discloses a containment and removal system for drag and sludge that constitutes a barrier to contain aqueous-in-organic carryover and/or organic-in-aqueous carryover, which can be used in a settler ( settler ) for solvent extraction processes, designed to filter the lees, generate the sedimentation of aqueous-in-organic droplets and/or or organic droplets in aqueous, and promote the coalescence of aqueous droplets from the organic phase, avoiding contamination of the organic and the electrolyte on the way to electrowinning, due to the presence of drag and sludge.

The containment and removal system of drags and litter corresponds to a picket system fence or fence of the cartridge type or cartridge, which comprises a plurality of cartridges arranged in an arrangement in the form of a run or row that extends to the width and height of the decanter and arranged in a normal direction to the flow of organic and aqueous. The cartridges are fixed to each other to form the run or row. To ensure the continued operation of the system, each cartridge comprises at least two interchangeable units, so that when a run or part of a run of interchangeable units is removed, there is always at least one run of interchangeable units that ensures that no section of the system is discovered.

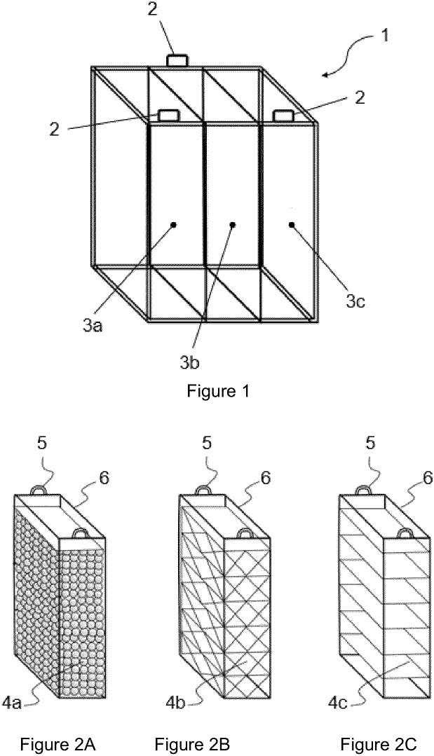

As shown in FIG. 1, each cartridge comprises a frame (1), with a straight perpendicular geometry, which includes fastening means (2) for fixing with other adjacent or neighboring cartridges; and guides that define a plurality of compartments that delimit separate spaces in the frame (1). In each compartment, exchangeable units can be inserted or mounted, so that the cartridge comprises a plurality of exchangeable units arranged one behind the other and adjacent to one another. The interchangeable units have a geometry that matches the shape of the compartments, comprising a frame (5) that includes lifting means (6) that allows them to be easily lifted and manipulated to be inserted into the compartments or removed. cartridge when required. The frame (5) of the interchangeable units defines a space that allows it to be filled with fluff-retaining elements, settlers, coalescers, or a combination thereof.

The compartments allow the installation of interchangeable units with different types of fillers, these being a first type of interchangeable unit (4a) (FIG. 2A) that has a filler oriented to retain fluff and other elements; a second or type of interchangeable unit (4b) (FIG. 2B) that has a filler of the coalescing type ; and a third type of interchangeable unit (4c) (FIG. 2C) having a packing for the sedimentation of aqueous-in-organic droplets and/or organic-in-aqueous droplets. Additionally, the interchangeable units can comprise a combination of the different types of filling, such that an interchangeable unit comprises at least fluff retainer elements, or settler elements, or coalescer elements. Typically the first type of interchangeable unit (4a) is inserted into the first housing compartment (1) of the cartridge so that the interchangeable unit faces the flow in the decanter.

The filling of the first type of interchangeable unit (4a) can be polyethylene shavings, PVC, other plastic materials, shavings or wood chips or a combination of these, which allow leech to be retained. The filling of the second type of interchangeable unit (4b) can be of the honeycomb type comprising a plurality of ducts with a square, circular, hexagonal section or any other shape that favors the coalescence of the aqueous drops. The honeycomb or similar filler can be made of polyethylene, PVC or other plastic materials. The filling of the third type of interchangeable unit (4c) can correspond to a panel of lamella-type inclined plates or another arrangement aimed at accelerating the sedimentation of aqueous drops in the organic phase that circulates above, and also of organic drops in the aqueous phase, which circulates through the lower zone. Other types of fillers can be considered, it being possible to use any type of filler that is efficient for the purpose of cleaning the organic and aqueous solutions of harmful contaminants for the following downstream process.

In a particular embodiment of the invention, the system is configured in such a way that the shell (1) of the cartridge comprises at least 3 compartments (3a, 3b, 3c) defined as a first compartment (3a), facing the flow, a second compartment (3b), behind the first compartment (3a) and a third compartment (3c), behind the second compartment (3c), where said compartments (3a, 3b, 3c) have the same dimensions. In this modality, interchangeable units with different types of filling are inserted for the containment and removal of carryovers and sludge, considering at least one of the three mechanisms that determine the magnitude of the sludge: filtration of the sludge, sedimentation of aqueous drops in organic and/or organic droplets in aqueous, and coalescence of aqueous droplets from the organic phase and coalescence of organic droplets from the aqueous phase.

In a specific configuration, the arrangement of interchangeable units consists of inserting in the first compartment (3a) an interchangeable unit corresponding to the first type of interchangeable unit (4a) to face the flow and retain the fluff and other elements; inserting into the second compartment (3b) an interchangeable unit corresponding to the second type of interchangeable unit (4b) that favors the growth of aqueous droplets by means of coalescence; and inserting in the third compartment (3c) an interchangeable unit corresponding to the third type of interchangeable unit (4c) that generates the settling of drops. In this configuration, the interchangeable units are arranged one behind the other, making it possible to promote individually, the retention of fluff by filtration, the sedimentation of aqueous droplets in organic and sedimentation of organic droplets in aqueous or the coalescence of aqueous and organic droplets in the respective complementary phases.

This arrangement favors the continuous operation of the system, increasing its availability, since the first type of interchangeable unit (4a), when facing the fluid, reduces the amount of sludge and other elements that pass through the second (3b). and third compartment (3c), while the second type of interchangeable unit (4b) in the second compartment (3b), allows growing the aqueous droplets in the organic phase and/or the organic droplets in the aqueous phase, thereby which improves the efficiency in subsequent sedimentation, which occurs in the third type of interchangeable unit (4c) inserted in the third compartment (3c).

Alternatively, the system considers arrangements of interchangeable units that consider at least one of the mechanisms identified above and/or a combination of the different types of padding in the same interchangeable unit.

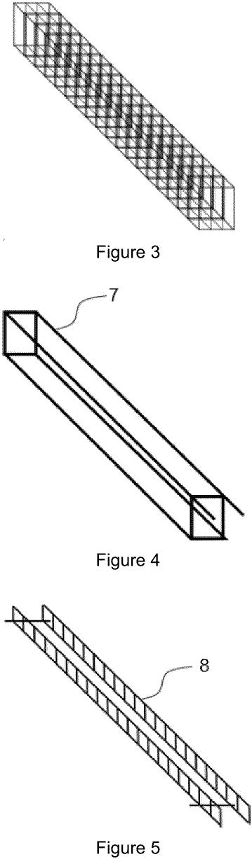

To form the system, the unitary cartridges are joined or assembled together by means of fastening means (2), available in the frames (1) of each cartridge, forming a containment barrier across the width of the decanter and normal to the organic flow. and aqueous, where said arrangement is illustrated in FIG. 3.

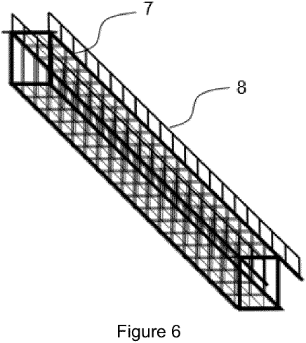

In one modality, to favor the stability of the cartridge arrangement, a holding structure (7) is used, as shown in FIG. 4, so that the cartridges of the system are mounted inside said holding structure (7). containing them. In addition, to facilitate access to the interchangeable units during the operation of the system, it can also comprise an upper corridor (8), as shown in FIG. 5, to be mounted on the support structure (7), in such a way that one or more operators can move on said upper aisle (8), facilitating access and safe handling of the interchangeable units. FIG. 6 schematically shows the embodiment of the invention in which the change system includes the support structure (7) and the upper passage (8).

System operation is designed so that when a run or part of a run of interchangeable units is removed, there is always at least one run of interchangeable units in the system to maintain continued stable operation. The change of interchangeable units is carried out when they are sufficiently worn or decomposed, dirty and/or clogged. Due to the configuration of the system, typically, the changeover sequence of interchangeable units is carried out from the units that face the flow to the units that follow, since said units that face the flow filter and remove lint first, therefore They get dirty and clogged first than the rest of the interchangeable units in downstream or downstream positions, requiring their replacement and cleaning more frequently than the others.

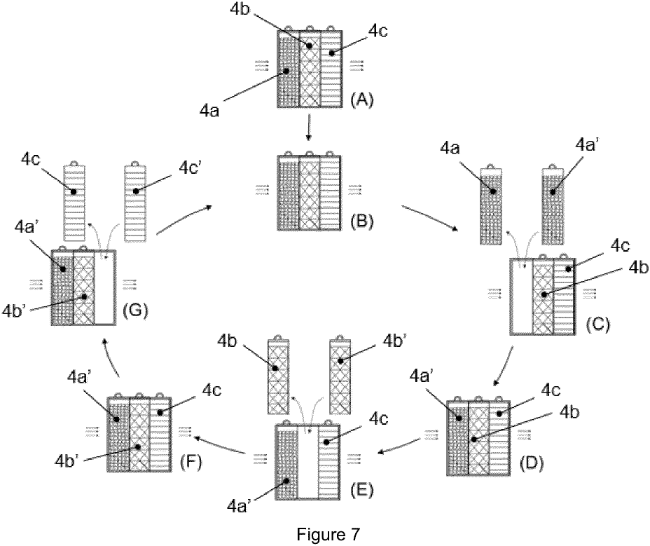

FIG. 7 shows an example of the exchangeable units change sequence, which allows maintaining the operation of the system in a stable and continuous manner in the mode in which the frame (1) of the cartridge comprises three compartments (3a, 3b, 3c) with an interchangeable unit corresponding to the first type of interchangeable unit (4a), an interchangeable unit corresponding to the second type of interchangeable unit (4b) and an interchangeable unit corresponding to the third type of interchangeable unit (4c), respectively. The exchangeable unit change sequence considers the following stages:
(A) Collect carryovers and clumps in interchangeable units that include fillers that promote physical clump retention, droplet coalescence, and droplet sedimentation. At this stage, the system operates in a stable manner, the interchangeable units are in charge of containing and removing drag and dregs in the flow;
(B) After a period of operation, the interchangeable units that face the flow become dirty and/or clogged due to filtration and retention of lees, and must be removed for cleaning;
(C) Remove the first run or row of interchangeable units corresponding to the first type of interchangeable unit (4a) for cleaning, replacing them with new interchangeable units of the first type (4a′);
(D) Continue the operation of the system until the interchangeable units in the second compartment (3b) of the cartridges become dirty and/or clogged;
(E) Remove the second run or row of interchangeable units corresponding to the second type of interchangeable unit (4b) for cleaning, replacing them with new interchangeable units of the second type (4b′);
(F) Continue the operation of the system until the interchangeable units in the third compartment (3c) of the cartridges become dirty and/or clogged;
(G) Remove the third run or row of interchangeable units corresponding to the third type of interchangeable unit (4c) for cleaning, replacing them with new interchangeable units of the third type (4c′).

The runs or rows of interchangeable units can be partially removed in the event that only some of said interchangeable units are found dirty and/or clogged, so that for each run or row they are removed at least partially as the interchangeable units are removed. dirty and/or clog during the operation.

In one embodiment, the removed exchange units can be replaced either by exchange units including the same type of fill or by exchange units with a different fill, depending on flow conditions.

The sequence is repeated again as long as the system is in operation and each time the exchange units become dirty and/or clogged.

In one embodiment, the interchangeable units are mounted and removed through the use of hoisting devices, for example, at least one hook or winch operated by an overhead crane.

In one modality, the cleaning of the interchangeable units is carried out outside the decanter, to later become part of the inventory of units that must be returned to the system when appropriate, after inspection and maintenance.

In modalities in which the frame (1) of the cartridges comprises another number of compartments, the sequence of exchangeable units is equivalent to that described for the case of three compartments, where the interchangeable units are removed from the first row or run. facing the flow, toward subsequent tiers or runs until reaching the interchangeable units in the last cartridge bay that forms the last run or tier of units furthest from the inflow. Once the interchangeable units from the last run or row have been replaced and cleaned, the sequence restarts again from the first run or row. This sequence is maintained cyclically while the system is in operation, that is, while the decanter is in continuous operation.

The system for containment and removal of drag and lint also includes an extraction or suction device for the application of a cleaning process in situ of the interchangeable units that face the flow, in order to increase the cleaning cycles of said interchangeable units. The extraction or suction device removes the fluff and drags adhered to the filling of the interchangeable units without the need for them to be removed from the system. The use of an extraction or suction device allows to maintain the operation of the system for a longer time without the need to change or replace said units due to dirt or clogging of these.

In one modality, the extraction or suction device comprises a suction tube or equipment in contact with the surface of the interchangeable units that face the flow to remove the fluff and adhering drags in its filling. The equipment or suction tube is connected to a suction pump that generates the suction. The pump, in turn, is in communication with a pond or tank that allows the storage of the removed lees and drags, for their separate treatment.

In another modality, the extraction or suction device allows the extraction to be carried out continuously by means of a vacuum, comprising a recuperator placed in the interchangeable units facing the flow; a vacuum pond in communication with the recuperator, which receives the lees and trawls from the recuperator; a vacuum system inside the vacuum tank to produce suction or aspiration by vacuum in the recuperator; and a pneumatic pump that extracts the lees from the vacuum pond to transfer them to containers for storage.

The extraction or suction device can comprise a suction element, suction equipment or recuperator arranged in each interchangeable unit that faces the flow, so that cleaning in situ is carried out simultaneously in all the units. Alternatively, the extraction or suction device comprises at least one suction element, suction equipment or recuperator that can be operated to modify its position, so that the same suction element can clean multiple interchangeable units sequentially, where the operation of the suction element can be manually, handled by an operator, or automatically.

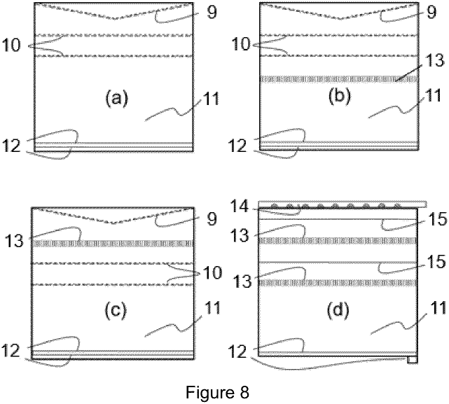

The system for the containment and removal of drag and sludge can be arranged as the only containment barrier in a decanter or in conjunction with devices or barriers for containment of drag available in the state of the art in traditional arrangements in a decanter. FIG. 8 (a) illustrates a traditional decanter that receives the mixture of the aqueous and organic phases, where said decanter includes containment barriers, comprising a first picket-type barrier arranged in a “V” (9). fence or fence in an entrance zone, which reduces the speed of a central zone; and two straight barriers (10) of picket type fence or fence downstream of the barrier arranged in “V” (9), where after the two straight barriers (10) there is a free sedimentation zone (11) and an exit zone that includes discharge compartments (12 ) for the discharge of the separated clean solutions. FIG. 8 (b) shows the configuration of the decanter in FIG. 8 (a) that includes an arrangement (13) of the containment and removal system for drag and sludge placed after the two straight barriers (10). FIG. 8 (c) shows the configuration of the decanter in FIG. 8 (a) that includes the arrangement (13) of the containment and removal system for drag and sludge placed between the barrier arranged in a “V” (9) and the two straight barriers (10). FIG. 8 (d) shows a post settler device, or DOC, comprising a feed manifold (14), upper and lower baffles (15), where the post settler includes a free sedimentation zone (11) and storage compartments. discharge (12) of the clean solutions as in the traditional decanter, where the post decanter also includes two arrangements (13) of the containment and removal system for drag and lees placed so that they alternate with the upper and lower baffles (fifteen).

1. A system for the containment and removal of drag and dregs in a decanter used in the solvent extraction process, which reduces the contamination of the phases due to the presence of drag and dregs, wherein comprises a plurality of cartridges, ordered and linked together, in an arrangement in the form of a run or row that extends across the width and height of the decanter arranged in a normal direction to the flow of organic and aqueous, where each cartridge comprises:
a frame (1) comprising holding means (2) for fixing with other adjacent cartridges and guides defining at least 2 compartments, with a first compartment facing the flow;
interchangeable units inserted in each compartment of the frame (1), comprising a frame (5) with a space to include a filling with at least fluff-retaining elements, coalescing elements, settling elements or a combination thereof ; and lifting means (6) on the frame (6) for lifting and manipulating said interchangeable units to be inserted into the compartments or removed from the cartridge when required.

2. The system for containment and removal of drag and litter according to claim 1, wherein the frame (1) of each cartridge comprises at least 3 compartments, these being: the first compartment (3a) facing the flow, a second compartment (3b) behind the first compartment (3a) and a third compartment (3c) behind the second compartment (3b).

3. The containment and removal system for drag and fluff according to claim 2, wherein each cartridge comprises at least a first type of interchangeable unit (4a) with a filling for the retention of fluff and other elements; at least a second type of interchangeable unit (4b) with a filler of the coalescer type of aqueous-in-organic and/or organic-in-aqueous droplets; and at least a third type of exchangeable unit (4c) with a packing for the settling of aqueous-in-organic droplets and/or settling of organic-in-aqueous droplets.

4. The system for containment and removal of drag and litter according to claim 3, wherein the first compartment (3a) has an interchangeable unit inserted, corresponding to the first type of interchangeable unit (4a), the second compartment (3b) has inserted an exchange unit corresponding to the second type of exchange unit (4b) and the third compartment (3c) has inserted an exchange unit corresponding to the third type of exchange unit.

5. The system for containment and removal of drag and lint according to claim 1, wherein the lint retaining elements are polyethylene shavings, PVC, other plastic materials, shavings or wood chips or a combination of these, which allow retain erases.

6. The system for containment and removal of drag and litter according to claim 1, wherein the coalescing elements They are of the honeycomb or similar type, preferably made of polyethylene, PVC or other plastic materials.

7. The system for containment and removal of debris and litter according to claim 6, wherein the honeycomb comprises a plurality of ducts with a square, circular, hexagonal section or any other shape that favors the coalescence of the drops of aqueous.

8. The system for the containment and removal of drag and sludge according to claim 1, wherein the settling elements are a panel of inclined lamella-type plates or another arrangement that accelerates the sedimentation of aqueous drops in the organic phase and also of organic droplets in the aqueous phase.

9. The system for the containment and removal of drag and litter according to claim 1, wherein comprises a holding structure (7) to contain the plurality of cartridges inside.

10. The system for containment and removal of drag and litter according to claim 9, wherein comprises an upper aisle (8) mounted on the holding structure (7), so that one or more operators can move on said upper aisle (8) to manipulate the interchangeable units.

11. The system for the containment and removal of drag and sludge according to claim 1, wherein also comprises an extraction or suction device for the application of a cleaning process in situ of the interchangeable units that face the flow, removing the erases and drags adhered in the filling of said interchangeable units.

12. The system for containment and removal of drag and litter according to claim 11, wherein the extraction or suction device comprises a suction tube or equipment in contact with the surface of the interchangeable units that face the flow.

13. The system for containment and removal of drag and litter according to claim 12, wherein the equipment or suction tube is connected to a suction pump that generates the aspiration, where the suction pump is in communication with a pond or deposit that allows to store the erases and drags removed.

14. The system for containment and removal of drag and waste according to claim 11, wherein the extraction or suction device operates by vacuum, comprising a recuperator placed in the interchangeable units facing the flow; a vacuum pond in communication with the recuperator, which receives the lees and trawls from the recuperator; a vacuum system inside the vacuum tank to produce suction or aspiration by vacuum in the recuperator; and a pneumatic pump that extracts the lees from the vacuum pond to transfer them to containers for storage.

15. A cartridge for the containment and removal of drags and dregs in a decanter used in the solvent extraction process, which reduces organic and electrolyte contamination due to the presence of drags and dregs, wherein includes:
a frame (1) comprising holding means (2) for fixing with other adjacent cartridges and guides defining at least 2 compartments, with a first compartment facing the flow;
interchangeable units inserted in each compartment of the frame (1), comprising a frame (5) with a space to include at least one filler with flint-retaining elements, coalescing elements, settling elements, or a combination thereof; and lifting means (6) on the frame (6) to lift and manipulate said interchangeable units to be inserted into the compartments or removed from the cartridge when required.

16. The cartridge for containment and removal of drag and sludge according to claim 15, wherein the frame (1) of each cartridge comprises at least 3 compartments, these being the first compartment (3a) facing the flow, a second compartment (3b) behind the first compartment (3a) and a third compartment behind the second compartment (3b).

17. The cartridge for containment and removal of drag and lint according to claim 16, wherein each cartridge comprises at least a first type of interchangeable unit (4a) with a filling for lint retention and other elements; at least a second type of interchangeable unit (4b) with a coalescing type filling; and at least a third type of interchangeable unit (4c) with a packing for the sedimentation of aqueous-in-organic droplets and/or organic-in-aqueous droplets.

18. The cartridge for the containment and removal of drag and fluff according to claim 17, wherein the first compartment (3a) has an interchangeable unit inserted corresponding to the first type of interchangeable unit (4a), the second compartment (3b) has an inserted exchange unit corresponding to the second type of exchange unit (4b) and the third compartment (3c) has inserted an exchange unit corresponding to the third type of exchange unit.

19. The containment and removal cartridge for drag and fluff according to claim 15, wherein the fluff-retaining elements are polyethylene shavings, PVC, another plastic material, shavings or wood chips or a combination of these that allow the retention delete.

20. The containment and removal cartridge for drag and lint according to claim 15, wherein the coalescing elements are of the honeycomb type or similar, preferably made of polyethylene, PVC or other plastic materials.

21. The cartridge for the containment and removal of drags and lint according to claim 20, wherein the honeycomb comprises a plurality of ducts with a square, circular, hexagonal section or any other shape that favors the coalescence of the drops of aqueous.

22. The cartridge for the containment and removal of drag and fluff according to claim 15, wherein the settling elements are a panel of inclined lamella-type plates or another arrangement that accelerates the sedimentation of aqueous drops in the organic phase and also of organic droplets in the aqueous phase.

23. A procedure for the containment and removal of drag and dregs in a decanter used in the solvent extraction process, which reduces the contamination of the phases due to the presence of drag and dregs, wherein includes the stages of:
a) collect the drag and dregs by means of at least two interchangeable units arranged one behind the other in a plurality of cartridges, ordered and linked together, in a run or row-shaped arrangement, which extends across the width and height of the decanter, arranged in a normal direction to an organic and aqueous flow, wherein said interchangeable units comprise packings that promote at least one mechanism for the physical retention of fluff, droplet coalescence or droplet sedimentation;
b) removing at least partially the first run or row of interchangeable units in the plurality of cartridges, which face the flow, when clogging;
c) replace the clogged interchangeable units of the first run or row, inserting new interchangeable units in the cartridges;
d) clean externally removed exchangeable drives;
e) repeat steps b) to d) sequentially for each of the runs or rows of interchangeable units until reaching the last run or row farthest from the flow inlet,
f) repeat steps b) to e) while the clarifier is in operation, restarting the sequence from the first run or row of interchangeable units.

24. The procedure for containment and removal of drag and litter according to claim 23, wherein the interchangeable units are removed and replaced by means of lifting devices.

25. The procedure for containment and removal of drag and litter according to claim 24, wherein the hoisting devices are at least one hook or toggle operated by an overhead crane.

26. The procedure for containment and removal of drag and lint according to claim 23, wherein the cleaning of the interchangeable units is carried out in situ, through the use of an extraction or suction device.
